(19) United States
(12) Patent Application Publication
(10) Pub. No.: US 2026/0170864 A1
(43) Pub. Date: Jun. 18, 2026

(54) PERIMETER-MOUNTED ULTRAVIOLET IMAGING AND NOTIFICATION SYSTEM FOR DETECTING SCORPIONS IN INDOOR LIVING SPACES

(71) Applicant: Matthew Lovato, Austin, TX (US)

(72) Inventor: Matthew Lovato, Austin, TX (US)

(21) Appl. No.: 19/420,307

(22) Filed: Dec. 15, 2025

Related U.S. Application Data
(60) Provisional application No. 63/734,666, filed on Dec. 16, 2024.

(51) Int. Cl. G06V 40/10; G06V 10/141; G06V 10/145; G06V 10/147; G06V 10/56; G06V 10/60; G06V 10/774; G06V 10/82; G06V 20/52; H04L 51/224; H04N 23/71; H04N 23/74

(52) U.S. Cl. CPC G06V 40/10; G06V 10/141; G06V 10/145; G06V 10/147; G06V 10/56; G06V 10/60; G06V 10/774; G06V 10/82; G06V 20/52; H04N 23/71; H04N 23/74; H04L 51/224

(57) ABSTRACT

Systems and methods are disclosed for detecting scorpions in indoor and semi-outdoor environments using perimeter-mounted hardware detector units, server-based image analysis, and user notification services. Each hardware detector unit is mounted near a perimeter surface and includes a downward-facing imaging module, one or more ultraviolet light sources with a UV pass filter, a microcontroller, and a wireless interface. The microcontroller determines ambient brightness from peripheral image regions and, when a darkness threshold is met, activates the ultraviolet light sources and captures images of a floor region at periodic intervals. Local firmware identifies candidate scorpion fluorescence by detecting greenish pixel clusters satisfying color, brightness, and size criteria and transmits candidate images and metadata to a server. A server-side image recognition model evaluates the images and, when a confidence threshold is met, associates a detection event with a user account and issues notifications to client applications according to per-user preferences.

### CROSS-REFERENCE TO RELATED APPLICATIONS

This application claims the benefit of U.S. Provisional Ser. No. 63/734,666 , filed on Dec. 16, 2024, entitled “This scorpion detection and notification system features a compact UV camera with LED bulbs powered by a USB wall adapter. The camera captures images under UV light and analyzes them for scorpions based on their UV fluorescence. Images are sent to a remote server for advanced image recognition. Upon confirmation, a notification is sent to appropriate users via a mobile app, which also manages account, user, camera, location, and event data. Users can also receive notifications via SMS or email,” the entire disclosure of which is hereby incorporated by reference.

### STATEMENT REGARDING FEDERALLY SPONSORED RESEARCH OR DEVELOPMENT

Not applicable.

### FIELD OF THE INVENTION

The present invention relates generally to systems and methods for detecting pests in residential and commercial environments, and more particularly to an ultraviolet (UV) imaging and notification system configured to detect scorpions within indoor and semi-outdoor environments using perimeter-mounted hardware, server-based image analysis, and network-connected client applications.

### BACKGROUND OF THE INVENTION

Scorpions are a significant safety concern in many regions, particularly in the southwestern United States. Scorpion stings can cause pain, medical complications, and anxiety for residents, especially families with children and pets. Scorpions may enter homes and semi-outdoor spaces such as garages and covered patios through small gaps, foundation cracks, utility penetrations, or around doors and windows. Once inside, they can travel throughout the structure and hide in shoes, furniture, bedding, and laundry. Occupants often first discover a scorpion only when stepping into a shoe, sitting on a couch, or entering a bedroom, sometimes resulting in stings. For families with young children, the presence of undetected scorpions in living and play areas is particularly unacceptable.

Existing consumer solutions for detecting scorpions inside a home are limited and often unreliable. One common approach is the use of glue or sticky traps placed on or near the floor. These traps occasionally capture scorpions but suffer from several drawbacks. Scorpions often exhibit thigmotaxis, a perimeter-hugging behavior in which they prefer to move along walls and surfaces where they feel physical contact on multiple sides. Even when traps are positioned near walls, scorpions may avoid the exposed adhesive surface. Over time, sticky traps accumulate dust, debris, and insects, which reduces their effectiveness and can make it difficult to visually inspect them. Sticky traps also provide no automated alerting capability—occupants typically only discover a scorpion if they happen to inspect the trap at the right time.

Another technique is manual inspection using handheld ultraviolet (UV) flashlights. Under certain UV wavelengths, scorpions fluoresce with a characteristic greenish glow, making them easier to spot in darkness. In practice, this method requires a person to darken the room, sweep the area with a handheld UV light, and visually look for glowing scorpions along baseboards, furniture edges, and other perimeter locations. This technique is time-consuming, requires the occupant to remember to perform inspections, and does not provide continuous monitoring while the occupants are asleep or away from home. It also depends heavily on user diligence and line of sight, and it does not keep a historical record of when and where scorpions were active.

Conventional indoor security cameras and smart home monitoring systems are generally optimized for visible-light video security and are not specifically designed for scorpion detection. These devices are often mounted at eye level or above and aimed toward doors, hallways, or general room areas. Their fields of view typically do not prioritize floor-level perimeters where scorpions naturally travel. Standard cameras also lack integrated UV illumination tuned to scorpion fluorescence and typically are not configured with optical filters or image analysis algorithms that distinguish scorpions from other objects based on their UV-induced glow. As a result, they are poorly suited for reliably detecting scorpions in low-light indoor or semi-outdoor environments.

Some pest control services may offer monitoring or notification capabilities in other contexts, such as networked rodent traps or door and window sensors, but these systems do not address automated detection of scorpions based on UV fluorescence along interior perimeters. Known approaches do not combine a dedicated floor-level, perimeter-mounted form factor aligned with scorpion thigmotaxis behavior, ultraviolet illumination and optical filtering selected to enhance scorpion fluorescence, and automated image analysis tuned for scorpions, integrated with a multi-user notification platform and a continuously trainable image recognition model.

Accordingly, there is a need for an automated detection system that (i) aligns with known scorpion behavior, including nocturnal activity and perimeter crawling; (ii) leverages UV-induced fluorescence to reliably highlight scorpions against their surroundings; (iii) automatically captures and analyzes images for scorpion presence in low-light or dark conditions; and (iv) provides timely notifications to homeowners and other authorized users through mobile and other communication channels. There is a further need for such a system to be easy to install using existing electrical infrastructure such as standard wall outlets, to support multiple users and devices under a single account, and to provide a feedback loop for improving detection accuracy over time using data collected from deployed devices in real homes and other occupied spaces.

### BRIEF SUMMARY OF THE INVENTION

In one aspect, the invention provides a scorpion detection system comprising one or more perimeter-mounted hardware detector units, a server-side image analysis and notification platform, and one or more client applications such as a mobile application and web interface.

Each hardware detector unit is configured to be mounted at or proximate to a perimeter surface, such as a standard wall outlet, in an indoor or semi-outdoor environment, and to monitor a floor-level region adjacent to the perimeter of the room. In certain embodiments, the hardware unit includes: an outer case secured to the wall outlet using a fastener; an inner frame supporting an imaging module and electronics; a microcontroller, such as an ESP32-CAM module, configured for image capture, local processing, and wireless communication; one or more 365 nm ultraviolet (UV) light-emitting diodes arranged to illuminate the monitored floor region; a UV pass filter positioned in front of the UV LEDs to enhance scorpion fluorescence; a switching element, such as a MOSFET, for controlling current to the UV LEDs; and a 5 V USB power input, without any internal battery.

The imaging module is oriented so that its field of view is directed toward the floor region in front of the outlet. The microcontroller determines ambient brightness using image data, for example, by computing a brightness metric from pixels along one or more edges of captured frames. When the brightness metric indicates that the environment is sufficiently dark, the microcontroller activates the UV LEDs and causes the imaging module to capture images of the illuminated floor region at periodic intervals.

Local firmware analyzes each captured image to detect clusters of pixels exhibiting characteristics consistent with scorpion fluorescence, including greenish coloration determined by RGB thresholds, brightness above a minimum level, and cluster size within a prescribed range. When the cluster criteria are satisfied, the hardware unit classifies the image as a candidate for detection and transmits the image and associated metadata over a wireless network, such as Wi-Fi, to a remote server. The metadata can include a device identifier, detector name and location, firmware version, LED behavior settings, ambient brightness metrics, and cluster statistics.

The server system, which may be implemented using one or more cloud-hosted instances, authenticates incoming transmissions from hardware detector units and stores the received images and metadata in a data store. An image recognition module on the server processes candidate images using a trained image recognition model, such as a YOLO-based neural network specialized for scorpion detection under UV illumination. For each candidate image, the model produces a confidence score. If the confidence score meets or exceeds a configurable detection threshold, the server designates the event as a scorpion detection, associates the event with a user account, and records the event for subsequent analysis. Images determined not to contain scorpions may be stored as negative examples and used, together with confirmed scorpion images, to retrain and improve the image recognition model over time. In some embodiments, the server system 200 maintains, for each Scorpion Detector 100, a configurable detection sensitivity parameter that defines a confidence threshold for scorpion detection. The detection sensitivity parameter may be set or adjusted via a client application, such as the mobile application 220, and may be represented, for example, as a numerical input field. The image recognition module 208 compares the confidence score generated for a given image to the confidence threshold associated with the corresponding detector, such that higher sensitivity settings require higher confidence scores to trigger alerts.

User accounts can be associated with one or more hardware detector units and with multiple user profiles, including an account owner and one or more guest users. A notification engine within the server system is configured to send detection alerts according to per-user preferences, including push notifications via a dedicated mobile application and, in some embodiments, text messages and email messages via a third-party messaging service. Each user can configure which communication channels generate alerts, and can select custom alert sounds for push notifications.

In another aspect, a mobile application provides an interface for creating and logging into accounts; registering and configuring hardware detector units on the user's Wi-Fi network by supplying network credentials; assigning detector names and locations; selecting LED behavior modes such as flashing or constant UV illumination; viewing status information and images for each detector; managing per-user alert preferences; managing guest users associated with the account; and removing or reassigning detectors. The mobile application receives push notifications of detection events and can display associated images and metadata to the user.

In another aspect, a web application provides informational content about scorpion risks and system usage, and serves as an e-commerce interface through which users can purchase hardware detector units in single units or multi-unit packs and manage service subscriptions, such as monthly or yearly plans. The web application may integrate with a payment processing service and communicate with the same backend used by the mobile application and hardware detector units.

In yet another aspect, each hardware detector unit supports over-the-air (OTA) firmware updates. The microcontroller periodically transmits a firmware version identifier to the server system as part of an update check. Based on the reported version and a repository of available firmware images, the server either indicates that the device is current or provides update metadata and a download location for a newer firmware image. The hardware detector unit downloads, verifies, and installs the updated firmware and then resumes operation, enabling remote deployment of improved detection heuristics, security updates, and new features without physical access to the device.

Collectively, these components provide a continuously operating system that aligns with scorpion thigmotaxis and nocturnal behavior, uses UV-induced fluorescence to highlight scorpions at floor-level perimeters, applies local and server-side image analysis to distinguish likely scorpions from background, and delivers timely notifications to occupants so that scorpions can be addressed before causing surprise encounters or stings in living and play areas.

### BRIEF DESCRIPTION OF THE DRAWINGS

FIG. 1 is a perspective view of an example Scorpion Detector hardware unit mounted to a standard wall outlet and oriented to monitor a floor region.

FIG. 2 is a block diagram of the Scorpion Detector hardware unit, including a microcontroller, camera, UV LEDs, MOSFET driver, UV pass filter, and power input.

FIG. 3 is a flow diagram of an example on-device detection method performed by the Scorpion Detector, including ambient brightness determination, UV illumination control, image capture, local green cluster detection, and transmission of candidate images to a server.

FIG. 4 is a system diagram of a scorpion detection system including a plurality of Scorpion Detectors, a server system, a mobile application, and a web application, all associated with one or more user accounts.

FIG. 5 is a flow diagram of an over-the-air (OTA) firmware update process for a Scorpion Detector, including periodic version checks, server responses, and installation of updated firmware.

FIG. 6 is a user interface diagram illustrating example mobile application screens for detector setup, configuration of LED behavior and alert preferences, and management of account guests.

### DETAILED DESCRIPTION OF EXEMPLARY EMBODIMENTS

The embodiments described herein relate to systems and methods for detecting scorpions in indoor and semi-outdoor environments using perimeter-mounted ultraviolet (UV) imaging hardware, server-based image analysis, and multi-channel user notifications. While specific implementations are described, the invention is not limited to the particular examples provided and may be embodied in various alternative forms. The elements, features, and operations described in connection with any particular embodiment may be combined with, or used instead of, those described in connection with other embodiments.

### Scorpion Detector Hardware

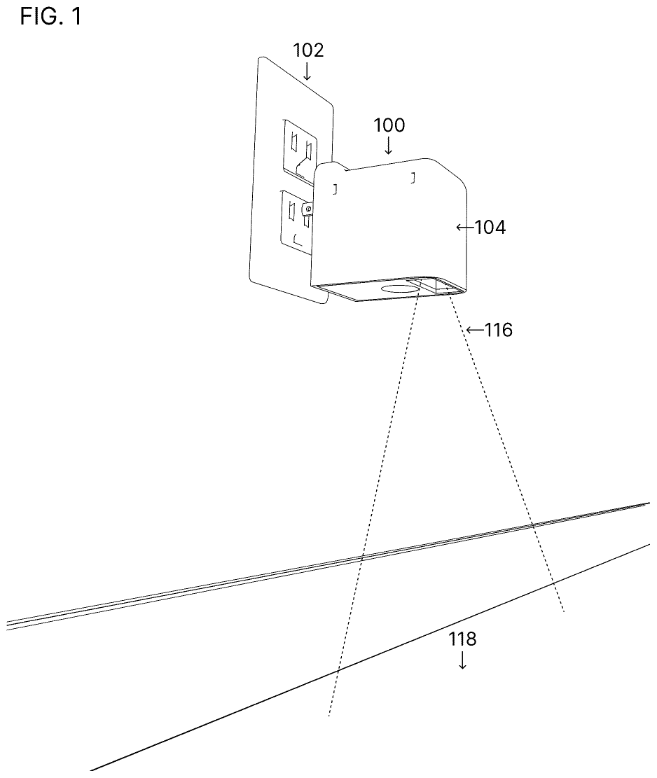

Referring to FIG. 1, in one embodiment a Scorpion Detector hardware unit 100 (also referred to herein as a hardware detector unit) is configured to be mounted at or proximate to a perimeter surface, such as a wall of a room, a garage, or a covered patio. In a particular implementation, the Scorpion Detector 100 is mounted to a standard U.S. wall outlet 102 located on the perimeter surface. The wall outlet 102 serves as an example of a mounting structure. The Scorpion Detector 100 includes an outer case 104 that covers at least a portion of the outlet 102 and that may be shaped to conform to typical duplex outlet geometries. The outer case 104 may be formed from a fire-retardant plastic or other suitable material and includes a fastener opening 106 aligned with an existing screw hole of the wall outlet 102. A fastener 108, such as a screw, secures the outer case 104 to the outlet 102, thereby increasing child safety and preventing easy removal. In other embodiments, the outer case 104 may be secured to a different mounting structure on the perimeter surface using other fastener types, such as anchors, brackets, or adhesive mounts.

The Scorpion Detector 100 further includes an inner frame 110 supported within the outer case 104. The inner frame 110 carries an imaging assembly 112 and an electronics assembly 114. The imaging assembly 112 may include a camera module integrated with, or in close proximity to, a microcontroller module such as an ESP32-CAM device. The imaging assembly 112 is oriented so that a field of view 116 is directed downward toward a floor region 118 adjacent to the perimeter surface, enabling monitoring of a perimeter path at or near floor level.

The electronics assembly 114 includes a microcontroller 120, which may be or include an ESP32-class system-on-chip with integrated Wi-Fi capability, a memory 122 storing firmware instructions, a wireless interface 124 (e.g., IEEE 802.11 b/g/n radio), and input/output circuitry 126. The electronics assembly 114 further includes a switching element 128, such as a MOSFET, for controlling current to one or more ultraviolet light-emitting diodes (UV LEDs) 130.

In one embodiment, the UV LEDs 130 comprise a pair of 365 nm, 5 mm through-hole LEDs mounted on the inner frame 110 such that their emission cones overlap across the floor region 118. A UV pass filter 132, such as a ZWB2 or UG1 type filter, is positioned in front of the UV LEDs 130 on a light path between the LEDs 130 and the monitored floor region 118. The UV pass filter 132 is selected to substantially pass ultraviolet wavelengths effective to induce scorpion fluorescence while attenuating non-UV components, thereby increasing the contrast of scorpions relative to the background as seen by the camera module. In some embodiments, no additional UV filter is required on the camera module itself; in other embodiments, the camera module may incorporate its own optical filter.

The Scorpion Detector 100 receives power via a power input 134. In certain embodiments, the power input 134 comprises a 5 V, 2 A USB power supply 136 that plugs into the wall outlet 102 and connects to a USB-A jack on the Scorpion Detector 100 via a USB cable 138. The 5 V output from the USB power supply 136 is routed to both the ESP32-CAM module and to the anodes of the UV LEDs 130. The cathodes (negative sides) of the UV LEDs 130 are connected to a middle terminal of the switching element 128, which in one implementation is a MOSFET. Another terminal of the MOSFET is connected to a ground return, such that the MOSFET controls the current path from the UV LEDs 130 to ground. A control terminal (gate) of the MOSFET is coupled to a general-purpose output pin of the ESP32-CAM microcontroller 120, with the grounds of the USB power supply 136 and the ESP32-CAM module tied together to provide a common reference. In such embodiments, the Scorpion Detector 100 does not include an internal battery and is powered solely from the wall-supplied USB power source 136. This configuration simplifies the device design and ensures continuous operation whenever the outlet is energized. In other embodiments, the power input 134 may comprise a different external DC power source or adapter while still providing low-voltage power to the electronics assembly 114.

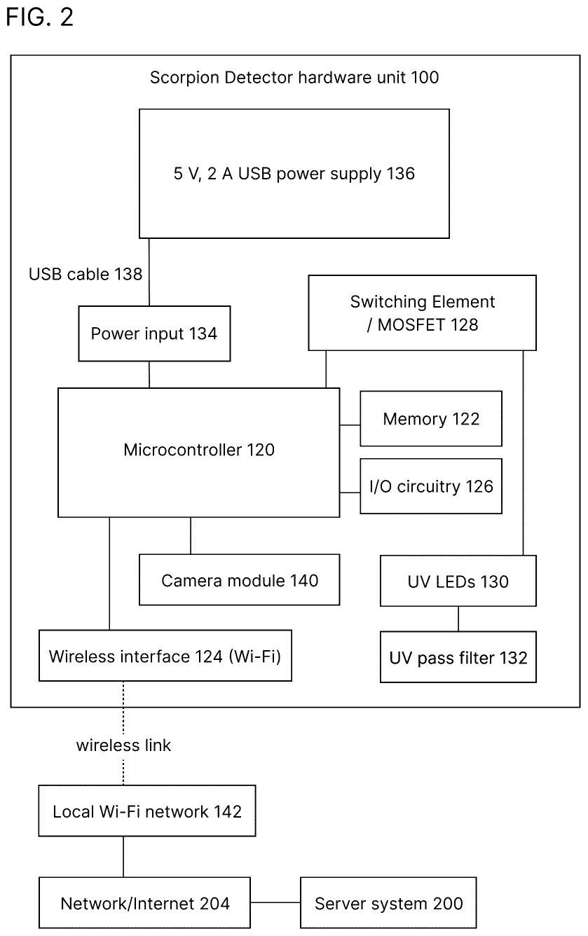

Referring now to FIG. 2, a block diagram of the Scorpion Detector 100 is shown. The camera module 140 is operatively coupled to the microcontroller 120, which is configured to capture image frames from the camera module 140 and to process the image data. The microcontroller 120 is further coupled to the MOSFET driver 128, which switches current through the UV LEDs 130 based on control signals from the microcontroller 120. The microcontroller 120 communicates with a remote server 200 via the wireless interface 124 and a local Wi-Fi network 142. Firmware stored in memory 122 configures the microcontroller 120 to perform operations described herein, including ambient brightness determination, UV LED activation, image capture, local cluster detection, image transmission, Wi-Fi setup procedures, reboot-on-failure logic, streaming of status information, and over-the-air firmware updates.

In some embodiments, the microcontroller 120 stores configuration data for the Scorpion Detector 100, including a detector name, a detector location description (for example, home, cabin, apartment identifier, room identifier, or garage), and settings for LED behavior such as flashing mode or constant-on mode. These configuration values may be set or updated by a mobile application or web application as described herein and persisted in non-volatile memory on the device.

### On-Device Image and Brightness Processing

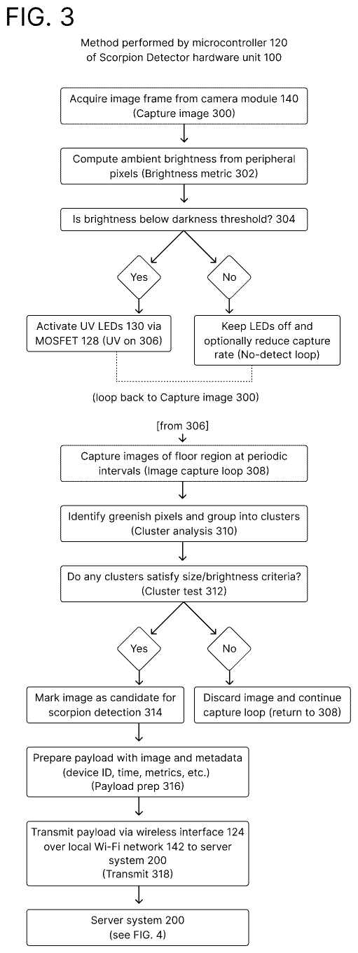

Referring to FIG. 3, in some embodiments the Scorpion Detector 100 determines ambient brightness using image data from the camera module 140, without requiring a separate light sensor. At step 300, the microcontroller 120 acquires an image frame from the camera module 140. At step 302, the firmware analyzes pixels located along one or more peripheral regions of the image, such as vertical strips along left and right edges of the frame. An average or other aggregate brightness metric is computed from these peripheral pixels.

At step 304, the computed brightness metric is compared to a configurable darkness threshold. When the brightness falls below the threshold, the firmware classifies the environment as dark. If the brightness metric indicates that the environment is not sufficiently dark, the UV LEDs 130 may remain off, and the device may reduce image capture frequency or enter a low-power monitoring state.

When the environment is determined to be dark, the microcontroller 120 activates the UV LEDs 130 via the MOSFET driver 128 (step 306), causing the floor region 118 to be illuminated by filtered UV light. While the UV LEDs 130 are active, the microcontroller 120 causes the camera module 140 to capture images of the floor region at periodic intervals, for example approximately once per second (step 308).

At step 310, the firmware performs a local color analysis to identify candidate scorpion fluorescence. In some embodiments, the captured image is represented in an RGB color space, and the firmware identifies pixels whose red, green, and blue components satisfy predetermined thresholds indicative of a greenish glow. For example, the firmware may require that a green channel value exceed both a minimum absolute value and the red and blue channel values by a margin, thereby defining a set of “greenish” pixels. The firmware may then segment the image into connected components or clusters of adjacent greenish pixels and compute cluster metrics such as area (pixel count), average brightness, and shape parameters.

At step 312, the firmware compares the cluster metrics to one or more criteria. Example criteria may include: (i) a minimum number of greenish pixels in a cluster; (ii) a maximum number of greenish pixels in a cluster to avoid large glare regions; (iii) a minimum average brightness of the cluster; and (iv) one or more geometric constraints such as minimum and maximum aspect ratios. If no clusters satisfy these criteria, the firmware may discard the image and repeat the capture process at the next interval.

If at least one cluster satisfies the criteria, the firmware classifies the image as a candidate scorpion detection (step 314). When a candidate detection is identified, the microcontroller 120 prepares a transmission payload comprising the captured image or a compressed representation of the captured image and associated metadata (step 316). The metadata can include a device identifier, a timestamp, firmware version information, detector name and location, LED behavior settings, ambient brightness metrics, cluster metrics, and one or more status flags. The payload is transmitted via Wi-Fi to the server 200 (step 318). In some embodiments, the microcontroller 120 may also support a streaming mode in which status and recent images are made available for live viewing by a mobile application as described herein.

In some embodiments, the firmware implements watchdog and reboot-on-failure logic. For example, the Scorpion Detector 100 may monitor for conditions such as repeated Wi-Fi connection failures, camera capture errors, or memory allocation failures, and may perform a controlled reboot of the microcontroller 120 in response to such conditions to restore normal operation.

### Server System and Image Recognition

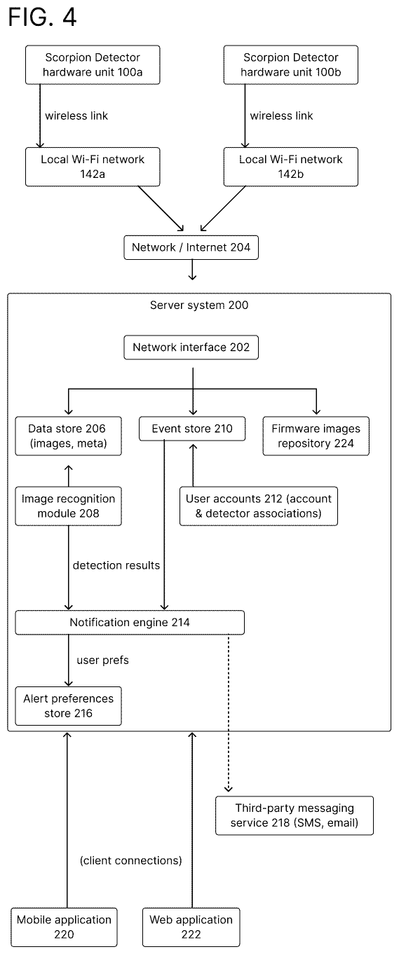

Referring to FIG. 4, the server system 200 may be implemented using one or more cloud-based virtual machines or containers, for example on an AWS EC2 platform, executing web server and application server components behind a reverse proxy. The server system 200 includes a network interface 202 configured to receive image payloads from a plurality of Scorpion Detectors 100 via a network 204, such as the Internet.

Upon receiving a payload, the server system 200 authenticates the source using device identifiers, cryptographic tokens, account associations, or any combination thereof. In some embodiments, the server system 200 stores device records in a data store 206 that link each Scorpion Detector 100 to an account record, a detector name, and a detector location description.

Authenticated images are stored in the data store 206 together with metadata such as device identifiers, detector location information, firmware version, LED behavior settings, brightness metrics, and local cluster metrics previously computed on the detector. The data store 206 may organize images by detection status, such as “candidate,” “confirmed scorpion,” and “false positive,” to facilitate subsequent model training.

The server system 200 further includes an image recognition module 208 implemented, for example, using a machine learning model trained to detect scorpions in images captured under UV illumination. In some embodiments, the image recognition module 208 comprises a YOLO-based neural network model trained specifically on scorpion images captured by Scorpion Detectors 100. In other embodiments, different neural network architectures or classifiers may be used while still performing automated scorpion detection.

The training dataset may include images of scorpions captured in real-world conditions and annotated as containing one or more scorpions, and may also include images that are confirmed not to contain scorpions. In certain embodiments, images initially classified as candidate detections may be reviewed manually or via user feedback (for example, mobile application users marking events as “scorpion” or “not a scorpion”), and resulting labels are used to update the training dataset with both true positives and false positives.

For each candidate image, the image recognition module 208 produces a confidence score that the image contains a scorpion. If the confidence score meets or exceeds a configurable detection threshold, the server system 200 designates the event as a scorpion detection and logs the event in an event store 210 associated with a user account 212. The server system 200 may store or update classifier outputs, bounding box coordinates, and associated metadata for analysis and future model improvements. Images that do not meet the detection threshold may be stored with corresponding confidence scores as negative examples and used to retrain the model to reduce false positives.

### Accounts, Guests, and Notification Management

Each user account 212 can be associated with one or more Scorpion Detectors 100 and with multiple user profiles, including an account owner and one or more guest users. The account owner may be a primary resident or property manager who has authority to add detectors, configure detector settings, manage subscription status, and invite or remove guest users. Guest users may be household members or other trusted individuals who receive alerts but do not control detector configuration.

A notification engine 214 within the server system 200 is configured to dispatch notifications for detection events according to per-user preferences stored in an alert preferences store 216. For example, each user profile may specify one or more notification channels such as:
push notifications delivered to a mobile application associated with the account;
text messages (SMS) sent to a registered phone number; and
email messages sent to a registered email address.

In one embodiment, push notifications are delivered via platform-specific push services such as Firebase Cloud Messaging (FCM) and the Apple Push Notification service (APNs) to instances of a Scorpion Alert mobile application running on user devices 220. Text messages and email messages may be transmitted via a third-party communications service 218, such as Twilio. The notification engine 214 may allow each user to configure custom alert sounds for push notifications and to enable or disable each notification channel on a per-detector or per-location basis.

The notification engine 214 may include logic to avoid excessive alerts by combining multiple detections within a time window, or by applying user-configurable quiet hours during which notifications are suppressed or limited to high-severity events.

### Mobile Application

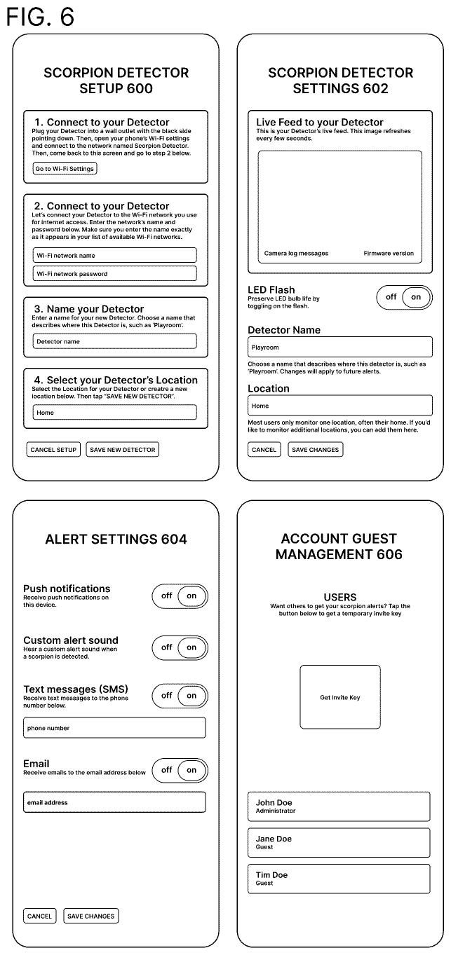

The mobile application 220 (FIG. 4, FIG. 6) provides a user interface for interacting with the scorpion detection system. The mobile application may be implemented using a cross-platform framework, such as React Native with Expo, and made available through mobile application stores. The mobile application communicates with the server system 200 via secure network connections to authenticate users and to retrieve account and detector information.

In one embodiment, the mobile application provides features including:
account creation and login using third-party identity providers, such as Google or Apple authentication;
registration of new Scorpion Detectors 100, including joining the detectors to a local Wi-Fi network by setting a network name (SSID) and password;
configuration of device-specific settings including Scorpion Detector name and location (e.g., “Home—Bedroom 1,” “Cabin—Living Room,” “Garage—Workbench”);
configuration of LED behavior modes (e.g., flashing versus constant illumination) that affect how UV LEDs 130 are driven during detection;
configuration of detection sensitivity or confidence threshold for scorpion alerts, for example by allowing the user to select a desired sensitivity level or to adjust a confidence threshold associated with each Scorpion Detector 100;
viewing of live or near-real-time status information for each detector, including recent images captured by the camera module 140 and logs of detection events;
receiving push notification alerts of scorpion detection events, with support for managing custom push notification sounds;
management of alert preferences per user profile, including enabling or disabling SMS and email channels and updating phone numbers and email addresses;
management of guest users for the account, including adding new guests and removing existing guests, where only account owners are permitted to manage associated Scorpion Detectors 100 and to modify detector settings; and
logging out of the application.

In some embodiments, when a detection event is received via push notification, the mobile application may present the corresponding stored image to the user along with metadata such as date, time, and detector location, allowing users to confirm or dismiss the event. User feedback on events may be transmitted back to the server system 200 and used to refine the image recognition model.

Referring to FIG. 6, example mobile application user interface screens include a Scorpion Detector setup screen 600, a Scorpion Detector settings screen 602, an alert settings screen 604, and an account guest management screen 606.

### Website and Subscription Management

A web application 222 (FIG. 4) provides an interface accessible via standard web browsers. The web application 222 may present informational content describing the scorpion detection system, risks associated with scorpions, behavior of scorpions such as thigmotaxis and nocturnal activity, and installation instructions for Scorpion Detectors 100.

The web application 222 also serves as an e-commerce portal through which users can purchase Scorpion Detectors 100 individually or in multi-unit packs and can subscribe to monitoring services using monthly or yearly plans. In some embodiments, the web application 222 integrates with a payment processing service, such as Stripe, to process one-time hardware purchases and recurring subscription charges. The web application 222 may communicate with the same server system 200 that manages detector data and notification services, enabling account owners to view their subscription status, billing history, and associated hardware units through a unified backend.

In one embodiment, a subscription grants access to continued server-side image analysis, notification services, and software updates. If a subscription lapses, the server system 200 may limit or disable certain features, such as server-side detection or notifications, while still permitting local operation of the Scorpion Detectors 100.

### Over-the-Air Firmware Updates

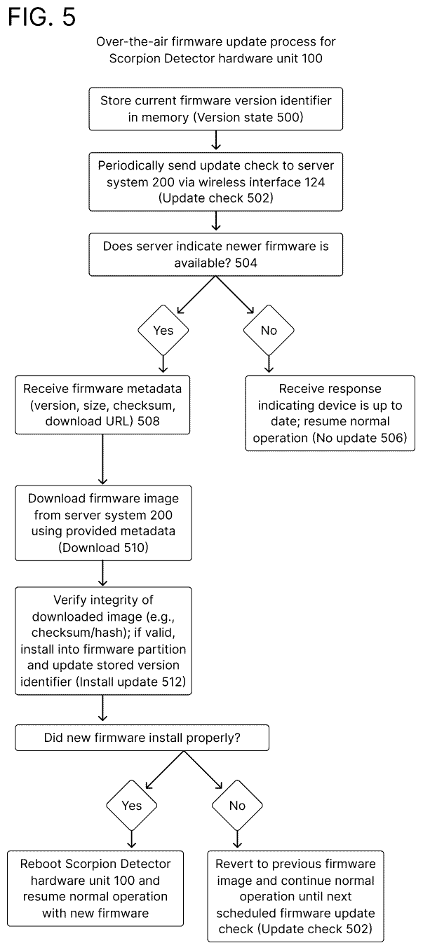

Referring to FIG. 5, the Scorpion Detector 100 supports over-the-air (OTA) firmware updates to enable deployment of new features, detection algorithms, and security patches without physical access to the hardware.

At step 500, the firmware on the microcontroller 120 maintains a stored version identifier representing the currently installed firmware. At step 502, the firmware executes a periodic update check process, for example once per hour. During each check, the Scorpion Detector 100 transmits an update request to the server system 200 via the wireless interface 124. The update request includes a device identifier and the current firmware version identifier.

At step 504, the server system 200 receives the update request and determines, based on the reported firmware version and a repository of available firmware images 224, whether a newer firmware version is available and authorized for the requesting device. If no update is available, the server system 200 may respond with a message indicating that the device is up to date, and the firmware resumes normal operation (step 506).

If an update is available, the server system 200 responds with metadata describing the new firmware image, such as version identifier, size, checksum, and a download endpoint (step 508). The Scorpion Detector 100 downloads the new firmware image (step 510) and verifies its integrity, for example by computing a checksum or hash and comparing it to the expected value provided by the server.

Upon successful verification, the Scorpion Detector 100 installs the new firmware image into a designated firmware partition or memory region (step 512) and updates the stored version identifier. The device may then reboot and begin executing the new firmware. In some embodiments, if the update fails or the new firmware does not boot properly, the device may revert to a previous firmware image. This OTA capability allows the system operator to iteratively refine brightness thresholds, color detection heuristics, network protocols, security measures, and other behaviors without service interruptions or physical device recall.

What is claimed is:

1. A scorpion detection system, comprising:
(a) a plurality of hardware detector units, each hardware detector unit configured to be mounted at or proximate to a perimeter surface of an indoor or semi-outdoor environment and comprising:
(i) an outer case configured to cover at least a portion of a mounting structure and including a mechanical fastener feature for attaching the outer case to the mounting structure;
(ii) an imaging module having a field of view directed toward a floor region adjacent to the perimeter surface;
(iii) one or more ultraviolet light sources configured to emit light at a wavelength effective to induce fluorescence in scorpions;
(iv) a UV pass filter optically associated with the one or more ultraviolet light sources;
(v) a microcontroller configured to control the imaging module and the one or more ultraviolet light sources;
(vi) a switching element operatively coupled in a current path of the one or more ultraviolet light sources and controlled by the microcontroller; and
(vii) a wireless communication interface configured to communicate over a local wireless network;
(b) a server system communicatively coupled to the plurality of hardware detector units via a network; and
(c) one or more client applications configured to communicate with the server system on behalf of one or more user accounts;
wherein the microcontroller of each hardware detector unit is configured to:
(i) acquire image data from the imaging module;
(ii) determine an ambient brightness level associated with the environment based at least in part on pixel values from one or more peripheral regions of the image data;
(iii) in response to the ambient brightness level falling below a darkness threshold, activate the one or more ultraviolet light sources via the switching element;
(iv) while the one or more ultraviolet light sources are active, cause the imaging module to acquire images of the floor region at periodic intervals;
(v) analyze image data from the images to identify one or more pixel clusters having color, brightness, and size characteristics consistent with scorpion fluorescence; and
(vi) when the one or more pixel clusters satisfy predetermined criteria, transmit to the server system the image and associated metadata via the wireless communication interface;
wherein the server system is configured to:
(i) authenticate transmissions received from the hardware detector units;
(ii) process received images using an image recognition model trained to detect scorpions;
(iii) determine that a given image satisfies a confidence threshold for containing a scorpion;
(iv) associate a detection event corresponding to the given image with a user account linked to a respective hardware detector unit; and
(v) cause a notification of the detection event to be transmitted to one or more client applications associated with the user account;
wherein the one or more client applications are configured to display information regarding the detection event and to provide interfaces for configuring one or more hardware detector units associated with the user account.

2. A computer-implemented method for detecting scorpions in an environment, comprising:
(a) mounting a hardware detector unit at or proximate to a perimeter surface such that a camera of the hardware detector unit has a field of view directed toward a floor region adjacent to the perimeter surface;
(b) acquiring, by a microcontroller of the hardware detector unit, image data from the camera;
(c) computing, by the microcontroller, an ambient brightness metric based at least in part on pixel values from one or more peripheral regions of the image data;
(d) determining, based on the ambient brightness metric, that the environment has a darkness level that satisfies a darkness threshold;
(e) in response to determining that the darkness level satisfies the darkness threshold, activating one or more ultraviolet light sources of the hardware detector unit through a switching element while continuing to acquire images of the floor region at periodic intervals;
(f) for at least a subset of the images acquired while the one or more ultraviolet light sources are active, identifying, by the microcontroller, one or more pixel clusters having color and brightness characteristics consistent with scorpion fluorescence by applying color thresholding to detect greenish pixels and grouping adjacent greenish pixels into clusters;
(g) determining that at least one of the pixel clusters satisfies one or more cluster criteria including at least a minimum cluster size;
(h) in response to determining that the at least one pixel cluster satisfies the one or more cluster criteria, transmitting, from the hardware detector unit to a server system via a wireless network, a payload comprising at least one corresponding image and metadata;
(i) processing, by the server system, the at least one image using an image recognition model trained to detect scorpions to generate a confidence score;
(j) determining, based on the confidence score, that the at least one image satisfies a detection threshold; and
(k) causing, by the server system, a notification of a scorpion detection event to be transmitted to at least one client application associated with a user account linked to the hardware detector unit.

3. The scorpion detection system of claim 1, wherein the one or more ultraviolet light sources comprise a pair of 365 nm, 5 mm through-hole LEDs.

4. The scorpion detection system of claim 1, wherein the UV pass filter is positioned in front of the one or more ultraviolet light sources and is configured to attenuate visible light while passing ultraviolet wavelengths.

5. The scorpion detection system of claim 1, wherein the microcontroller is an ESP32-CAM module comprising an integrated Wi-Fi radio and camera interface.

6. The scorpion detection system of claim 1, wherein the power input comprises a 5 V, 2 A USB power supply configured to plug into an electrical outlet, and wherein the hardware detector unit does not include an internal battery.

7. The scorpion detection system of claim 1, wherein determining the ambient brightness level comprises computing a brightness metric from pixel values located along left and right edges of an image captured by the imaging module.

8. The scorpion detection system of claim 1, wherein analyzing the image data to identify the one or more pixel clusters comprises:
(a) identifying pixels satisfying RGB thresholds indicative of green fluorescence; and
(b) grouping adjacent ones of the identified pixels into clusters.

9. The scorpion detection system of claim 1, wherein the image recognition model is a YOLO-based neural network trained using images captured by the plurality of hardware detector units under ultraviolet illumination.

10. The scorpion detection system of claim 1, wherein the server system is further configured to store images that the image recognition model classifies as not containing a scorpion as negative examples and to use the negative examples to retrain the image recognition model.

11. The scorpion detection system of claim 1, wherein each user account comprises an account owner and one or more guest users, and wherein notification preferences for the detection event are configurable on a per-user basis.

12. The scorpion detection system of claim 1, wherein the server system is configured to transmit push notifications to mobile devices via a push notification service and to transmit text messages and email messages via a third-party messaging service.
